(19) United States
(12) Patent Application Publication
(10) Pub. No.: US 2004/0052374 A1
(43) Pub. Date: Mar. 18, 2004

(54) High-security encoding device for remote controller

(75) Inventors: Yung-Cheng Lee, YunLin (TW); Chia-Ju Wu, YunLin (TW)

Correspondence Address: BRUCE H. TROXELL, SUITE 1404, 5205 LEESBURG PIKE, FALLS CHURCH, VA, 22041, US

(73) Assignee: Holltek Semiconductor Inc.

(21) Appl. No.: 10/647,350

(22) Filed: Aug. 26, 2003

(30) Foreign Application Priority Data
Aug. 30, 2002 (TW) 91119738

(51) Int. Cl. H04K 1/00

(52) U.S. Cl. 380/255

(57) ABSTRACT

The invention illustrates a high-security encoding device for remote controller, comprising: a timer, which is used to provide a transmitting time; a mode selector, which is used to provide a mode select value; a controller, by which an identity, the transmitting time, and the mode select value are received to generate a control signal; a key; an encryptor, which receives the control signal and applies the key to encrypt the control signal into a ciphertext; and a radio-frequency (RF) modulator, which modulates and thereafter outputs the ciphertext. The present invention further illustrates a method to improve the electricity consumption of remote controller, which includes: initiating an encoding device; initiating a timer of the encoding device; encrypting both a transmitting time and the identity of the timer and forward thereof to a decoding device; the decoding device comparing the received data with its own timing; synchronizing the timer of the decoding device and the timer of the encoding device; determining that whether or not the encoding device is again actuated during a period of time; if not, then the timing is stopped while the final timing value is still stored in a memory, if the encoding device is actuated again during the period of time, then repeating the hereinbefore steps until the controlled apparatus is activated.

### FIELD OF THE INVENTION

This invention is related to an encoding device for remote controller, specifically to a high-security encoding device for remote controller. The characteristic of the present invention is that by replacing counters used in the prior arts with timers to make a “mask-replay” attack hard to succeed, thus, the security of the remote control system is enhanced and also the electricity consumption problem of remoter controller is improved.

### BACKGROUND OF THE INVENTION

Nowadays, remote controller has become one of the daily-use appliances. All without exception that remote controller is applied on cars, front doors, and even audio-video equipment for the sake of convenience. Although there is no need to apply security mechanisms to some remote control subjects so that misusing or stealing can be prevented. But there are even more applications take security as their prior consideration. For example, remote controller for automobile shall be able to prevent burglars from sealing the car, even audio-video equipments will require some kind of security design to prevent children from watching programs that are not appropriate.

General speaking, a remote control system can be divided into a one-way operating mode and a two-way operating mode. In a one-way operating system, control signals are emitted entirely from the transmitting end to control remotely the appliances at the receiving end; yet, in the two-way operating system, control signals are emitted interactively between the transmitting end and the receiving end to ensure the objective of control. Although a two-way operating system can achieve a mutual authentication and has a better control effect, but owing to the complexity and cost of its equipments, it is seldom used except in some important situations.

The most simple remote control system is that a control signal is transmitted directly in plaintext to a receiver by radio. If every plaintext transmitted is the same, an attacker can simply replay the eavesdropped signal by using a scanner to accomplish the attack successfully. Accordingly, the system is extremely unsecured. Even signals transmitted in the system include some non-stationary values, e.g. random numbers and times, if attackers comprehend the system's framework and operating method (usually can be acquired with ease), an effective signal can be counterfeited and the system can be attacked with success.

A more secure method is to encrypt control signals appropriately before emitting. The receiving end will decrypt the signals and then proceed further. If a secured encryptor is adopted, attackers will have no way to know the accurate contents of control signals. Nevertheless, if a system is the same as the above-mentioned that a transmitted data is identical every time, an attacker after eavesdropping the signal can also simply replay the signal to accomplish an attack successfully. That is, the system is still not secured. In another case, if signals transmitted by the system are not stationary, but rather generated using several random numbers or codebook, when the random number or the entropy of the codebook is large enough, even an attacker who knows the system's framework and operating method but without an accurate key will have no way to counterfeit an effective data so as to attack the system successfully. However, due to the following factors, the safety of a traditional remote controller is under suspicion:

1. The quantity of random number or the size of codebook of traditional remote controller;

2. Unsecured system framework and operating method of traditional remote controller.

The above-mentioned factors enable the attackers to guess the contents of signals with ease, or through the recording of total control signals to successively transmit thereof to activate the receiver. Hence, a traditional remote controller, no matter the control signals are encrypted or not, is vulnerable to be attacked.

To achieve the safety requirement of remote controller, a modem cipher technique must be used. The crypto-system is divided into symmetric key crypto-system and asymmetric key crypto-system that can be summarized as following:

1. Symmetric key crypto-system: The symmetric key crypto-system is also addressed as traditional crypto-system with reference to FIG. 1A. Within the system of FIG. 1A, the encrypting key 1 of transmitting end is exactly the same as the decrypting key 2 of the receiving end. In operation, the encryptor 3 first applies the encrypting key 1 to encrypt a plaintext M into a ciphertext C. After the receiving end receives the ciphertext C, the decryptor 4 applies the decrypting key 2 which is exactly the same as the encrypting key 1 to decrypt the ciphertext C back into the plaintext M. According to the data encryption standard (DES) of U.S. National Standard, a plaintext of the input end is split up into a plurality of blocks using 64 bits as a unit, and then each block is encrypted into 64 bits ciphertext C using a 64 bits key; the receiving end applies a same key K to decrypt the ciphertext C into plaintext M. Since the plaintext and the ciphertext are equivalent in length, it is economic for transmission.

2. Asymmetric key crypto-system: The asymmetric key crypto-system is also addressed as public key crypto-system with reference to FIG. 1B. Within the system of FIG. 1A, the encrypting key 1′ of transmitting end is not identical to the decrypting key 2′ of the receiving end. Take the famous Rivest-Shamir-Adelman (RSA) crypto-system for instance, an input plaintext M is encrypted into the ciphertext C using a public key 1′ of the receiving end, i.e. C=M^{e} (mod N). The receiving end receives the ciphertext C then applies the private key 2′ of its own to decrypt the ciphertext C back into the plaintext M, i.e. M=C^{d} (mod N). Wherein N is an open value of the system that is equal to the product of the two prime number p and q, and e·d=1mod (φ (N)). In an asymmetric key crypto-system, for security sake, the value of N is usually very large (at least 1024 bits in length), and calculation time is long-winded because exponential operation is adopted. Hence, the asymmetric key crypto-system is difficult to accomplish by single-chip method, but rather by a software means in cooperate with high-speed computer. Nevertheless, the asymmetric key crypto-system has a certification function, which is essential in Internet and e-commerce application.

Focusing on the most prevailing remote control system with reference to the remote control system illustrated in U.S. Pat. No. 5,517,187, wherein FIG. 2A and FIG. 2B depict respectively schematic drawings of a transmitter and a receiver of the system. In FIG. 2A, the transmitter 10 includes: a counter 11, which provides a transmitting count C_{T}; a mode selector 12, which provides a mode select value M₀; a controller, by which the transmitting count and the mode select value are received to generate a control signal that is represented as plaintext M; a key 14; an encryptor 15, which receives the control signal and applies the key 14 to encrypt the control signal into ciphertext C; and a RF modulator 16, which modulates and thereafter outputs the ciphertext. In FIG. 2B, the receiver 20 includes: a RF modulator 16′, which demodulates the signals emitted from the transmitter; a key 14; a decryptor 15′, which receives the demodulated signals and decrypts the demodulated signals into plaintext M by applying the key 14; a counter 11, which generates a receiving count C_{R}; a controller 13, which receives the plaintext and the receiving count; and a checker 17, which checks whether the value of the counter is correct or not to decide whether the execution should continue.

Wherein, the control signal M of the transmitter includes a mode select value M₀ and a transmitting count C_{T}, that is:

M={M₀,C_{T}}

Wherein M₀ is the value of the mode select register that is 32 bits in length, and contents the mode select keystroke information, product number, other relevant and reserved bits, etc. Mode selection can be divided into a normal mode and a synchronized mode, in both the checking of data transmitting and receiving are similar and the only differences is in the bits of data and the range to be checked. C_{T} is the value of the counter and the total length of counter is 32 bits, therefore its codes is 2³² in total. For an ordinary remote controller, it is sufficient for security reason.

There is a common key K in both the transmitting end and the receiving end of the system, and each has a 32 bits counter. Every time the system starts to operate or revive, the content of the counter of the receiving end C_{R} is the counter of the transmitting end C_{T} plus 1. Before each transmission, a value of 1 is added to the value of the counter of the transmitting end. The transmitting end encrypts the above-mentioned data M using K with the symmetrical key method, and then transmits the data to the receiving end.

In summary, the characteristics of the operating method of remote control system with reference to U.S. Pat. No. 5,517,187 is that, after the receiving end receives signals outputted from the transmitting end, the system will check:

1. To decide whether it is in a normal or a synchronized mode;

2. To decide whether the transmitting count C_{T} received match with the receiving count C_{R}, i.e. n≧C_{T}−C_{R}≧0; wherein, n is a coefficient related to safety. For example, n=5 represents that the system is allowed no more than five transmission failures;

3. If the above-mentioned two steps are conformed, then synchronize the counter (i.e. make C_{R}=C_{T}+1) and actuate switch; If not, then no action will be made. At this time, if the transmitting end emits a signal of synchronization request, the system then enters into the synchronized mode and, after the request is executed, the counter of the receiving end and the transmitting end are synchronized and act normally. (The procedure is the same as the normal steps, except that the data transmitted is changed to another set of codes and counts while the safety coefficient is enlarged (e.g. n=100 etc.); and

4. If both the normal and the synchronized mode can not activate the receiver, the controller shall be send back for repair or re-write.

However, there is a major drawback of this system. That is, if an attacker masks a signal while it is being transmitted by the system so that the receiving end 20 can't receive the signal normally, the receiving end will not operate accordingly. When an ordinary user puts a remote controller to use for several times and the receiver 20 cannot operate normally, the user usually will leave and asks for support. Nevertheless, if an attacker 5 replays a signal to the receiving end 20 right at this time, as long as the value of the counter is within a reasonable range, the receiving end 20 will operate normally, i.e. the attack is a success. In the synchronized mode, similar to the above situation, an attack also will succeed. Because of the openness essence of radio remote control signal, in addition to the easiness for attackers to purchase any kind of scanner needed, a law-breaker can easily eavesdrops and records any signal transmitted. As seen in FIG. 3, through transmitting mask, signal eavesdropping and signal replaying (in brief, “mask-replay”), an attack can be achieved with ease.

Moreover, the present invention also comprises a rolling code system and a hopping code system. In the rolling code system, every time a receiver receives a signal, no matter the signal is correct or not, a value is added to the counter, e.g. 1. Therefore, in each normal operation, if a signal is eavesdropped by an attacker and replayed to the receiver, whereas the value of the counter of the receiver is larger than the signal itself, the receiver can not operate normally. For instance, a count of a transmitter starts with 100 and a count of a receiver starts with 101, the count of the transmitter is changed to 101 while the transmitter emits a signal; When the receiver receives the correct signal, since the count of the receiver is equal to the count of a transmitter, the system will operate normally and increases the count by 1 to change the value of the count to 102. If an attacker detects and records the transmitted signal whose content of the count is 101 and replays the signal to the receiving end, whereas the counter of the receiving end has been changed to 102 and is not the same as the replayed signal, the system will cease to operate. However, if an attacker replays the signal again and again, though the receiving end won't operate normal output, the count of the receiving end keeps accumulated to an extent that it exceed the safety range so that the system stops operating henceforth and has to be send back to the manufacturer for resetting.

Hence, in a rolling code system, if an attacker uses the above-mentioned method to mask the signal to enable the count of the receiving end to remain the same, thereat the attacker replays the eavesdropped signal and the system will operate normally, i.e. the attack succeeds.

Furthermore, a hopping code system is the same as the above-mentioned except that its counter applies a hopping output (i.e. can be achieved by applying a virtue random number generator), and is also difficult to resist a “mask-replay” attack.

Therefore, seeing the drawbacks of the foregoing prior arts, the focal point of the present invention is to provide a high-security encoding device for remote controller that not only can resist the “mask-replay” attack, but also improve the electricity consumption problem of remote controller.

### SUMMARY OF THE INVENTION

Seeing that the drawbacks of the prior arts, the focal point of the present invention is to provide a high-security encoding device for remote controller, wherein a timer is used to successfully resist the “mask-replay” attack so that system security is improved.

To achieve the above-mentioned objective according to the present invention, the present invention illustrates a high-security encoding device for remote controller that includes: a timer, which is used to provide a transmitting time; a mode selector, which is used to provide a mode select value; a controller, in which an identity, the transmitting time, and the mode select value are received to generate a control signal; a key; an encryptor, which receives the control signal and applies the key to encrypt the control signal into a ciphertext; and a radio-frequency (RF) modulator, which modulates and thereafter outputs the ciphertext.

The length of timer is different according to design needs, where 8-bits, 16-bits, or 32-bits is most commonly used.

In a preferred embodiment, the key is a 64 bits key, and the bits size can be increased or decreased according to necessity, e.g. 16, 32, 128 bits etc.

In a preferred embodiment, the key is stored in a non-volatile memory or in a one-time program ROM.

The length of the transmitting time is depended on the chosen timer, e.g. in a 32 bits timer that the length of transmitting time is 4 bytes, which is used to check whether or not the time difference between the timer of the encoding device and the timer of the associated encoding device is within a tolerance time.

In a preferred embodiment, the length of the mode select value is 2 bytes, by which a mode is chosen among the normal mode, emergency mode, and synchronized mode according to actual need.

In a preferred embodiment, the length of identity is 2 bytes, which is used for testing and verifying the associated decoding device.

In a preferred embodiment, the control signal is represented as plaintext M.

In a preferred embodiment, the ciphertext is encrypted using the symmetric key crypto-system.

In a preferred embodiment, the timer is realized by a single-chip timing-interrupt method.

In a preferred embodiment, the timer is realized by a logic circuit.

The present invention further illustrates a method for the improvement of electricity consumption of remote controller, which includes: initiating an encoding device; initiating a timer of the encoding device; encrypting a transmitting time and an identity of the timer and forward it to the decoding device; the decoding device comparing the received data with its own timing; synchronizing the timer of the decoding device and the timer of the encoding device; determining whether the encoding device is again actuated during a period of time; if not, the timing is stopped but still the final timing value is stored in a memory, if the encoding device is again initiated, then repeat the hereinbefore steps until the controlled appliance is activated.

The object, spirit and advantages of the present invention will be readily understood by the accompanying drawings and detailed description.

### BRIEF DESCRIPTION OF THE DRAWINGS

FIG. 1A is a block schematic diagram that illustrates the symmetric key crypto-system;

FIG. 1B is a block schematic diagram that illustrates the asymmetric key crypto-system;

FIG. 2A is a block schematic diagram that illustrates the transmitter of the remote control system according to U.S. Pat. No. 5,517,187;

FIG. 2B is a block schematic diagram that illustrates the receiver of the remote control system according to U.S. Pat. No. 5,517,187;

FIG. 3 is a block schematic diagram that illustrates the “mask-replay” attacking method of the remote control system according to the prior arts;

FIG. 4A is a block schematic diagram that illustrates an embodiment of the encoding device for remote controller according to the present invention;

FIG. 4B is a block schematic diagram that illustrates an embodiment of the decoding device for remote controller according to the present invention;

FIG. 5 is a block schematic diagram that illustrates an embodiment of timer according to the present invention;

FIG. 6 is a block schematic diagram that illustrates another embodiment of timer according to the present invention; and

FIG. 7 is a chart that illustrates the relationship between tolerance time, safe time, timing chip accuracy and time-between-operation of the decoding device according to the present invention;

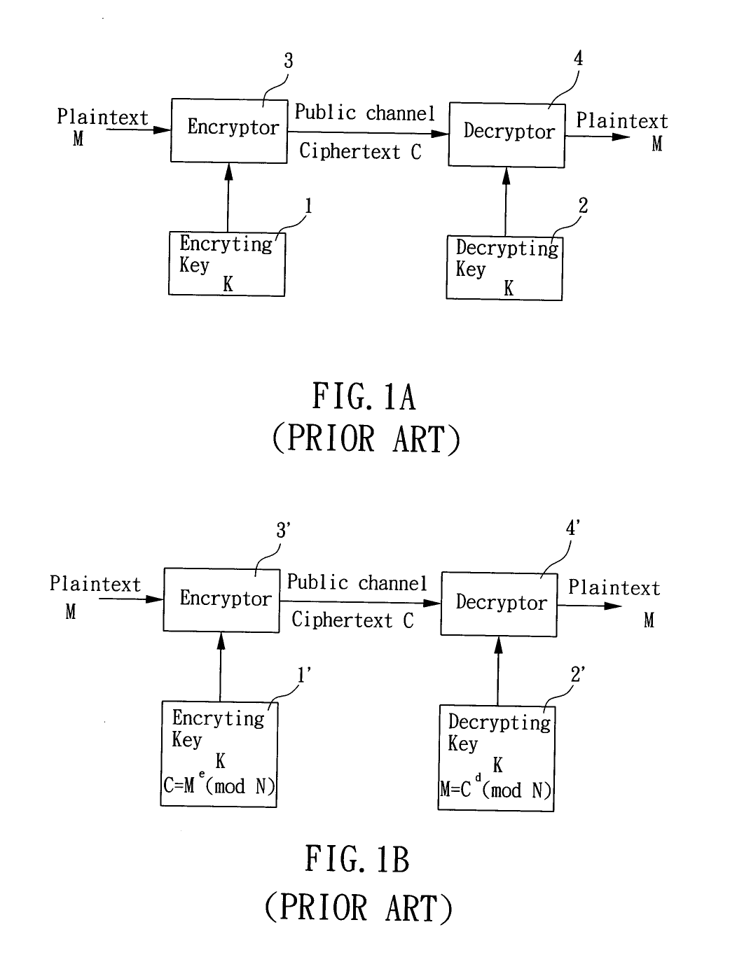

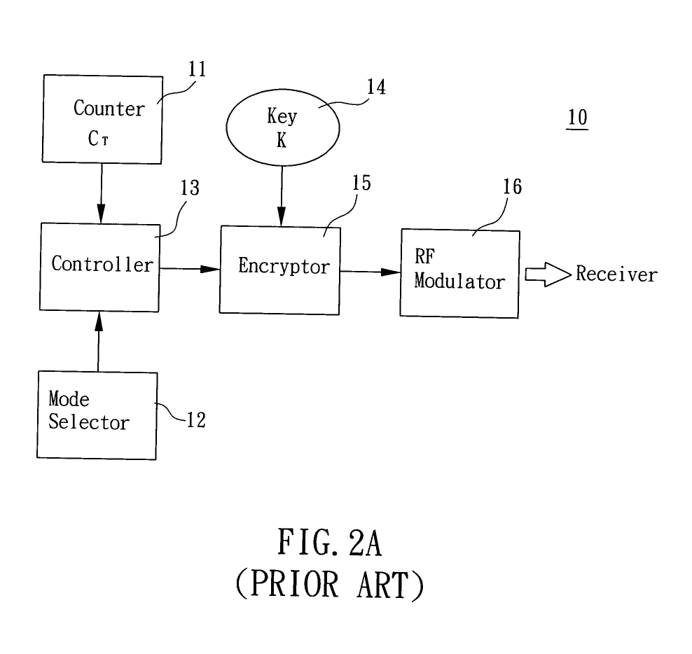

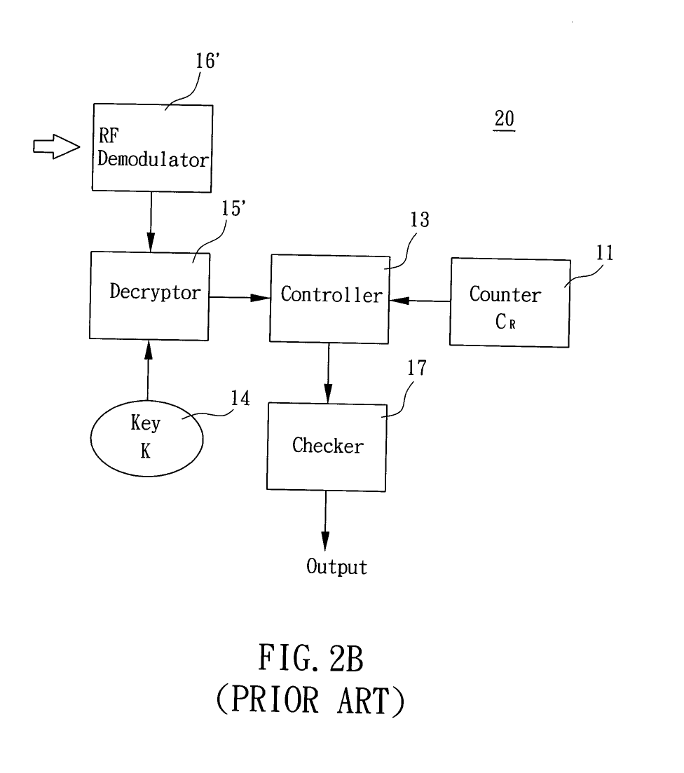

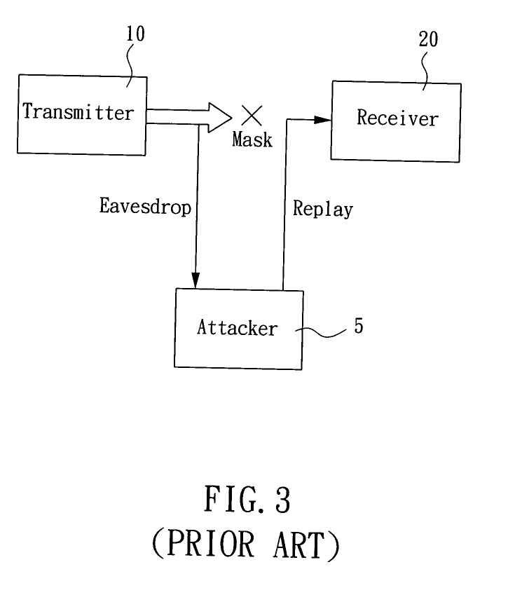

### DETAILED DESCRIPTION OF THE INVENTION

The invention illustrates a high-security encoding device for remote controller, wherein the characteristic of the present invention is that by replacing counters used in the prior arts with timers to make a “mask-replay” attack hard to succeed, thus, the security of the remote control system is enhanced and also the electricity consumption problem of remoter controller is improved. Please refer to the following drawings for better understanding of detailed descriptions of the present invention, which the same reference numbers represent the same components.

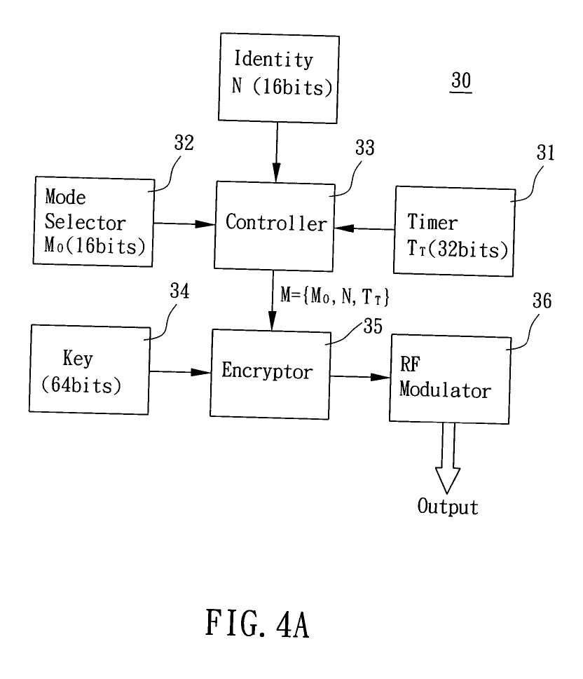

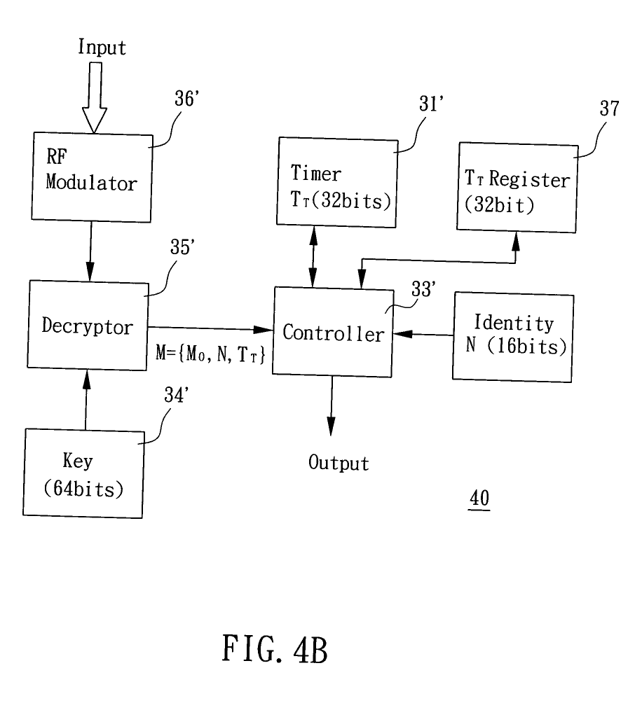

Please refer to FIG. 4A, which is a block schematic diagram that illustrates an embodiment of the encoding device for remote controller according to the present invention. In FIG. 4A, The encoding device 30 comprises: a timer 31, which is used to provide a transmitting time T_{T}; a mode selector 32, which is used to provide a mode select value M₀; a controller 33, by which an identity N, the transmitting time, and the mode select value are received to generate a control signal; a key 34; an encryptor 35, which receives the control signal and applies the key 34 to encrypt the control signal into a ciphertext C; and a RF modulator 16, which modulates and thereafter outputs the ciphertext.

In detail, within the encoding device of the present invention, the timer is a 32 bits timer and the key is a 64 bits key. The key is stored in a non-volatile memory, such as ROM or EPROM.

The control signal is represented as plaintext M: M={Mo,N,T_{T}}, wherein Mo is a mode select value, N is an identity, and T_{T} is a transmitting time, that are illustrated respectively as following:

1.Mo: The mode select value (Mo) is 2 bytes in length including mode select value and other reserved data, by which a mode is chosen among normal mode, emergency mode, and synchronized mode according to actual need.

1) Normal mode: The normal mode is used in normal operation. In this mode, the tolerance time T_{L} of an associated decoding device is smaller. Tolerance time is the maximum error value between timers of the encoding device and the decoding device that are set by the decoding device to ensure the system can operate normally. Tolerance time is usually larger than safe time. The safe time is an actual error value between timers of the encoding device and the decoding device. For instance, if accuracy of timer is ±10·10⁻⁶, the actual maximum error value of timers between the encoding device and the decoding device will be 20·10⁻⁶, about 2 sec/day. The safe time corresponds to 30 days is one minute. If a tolerance time is twice the safe time, which means an error value between timers of the encoding device and the deciding device can be allowed to be two minutes. In this way that the system can be assured to operate normally without the system-inoperative problem caused by an increase of system timing error.

2) Emergency mode: If timing error between the encoding device and the decoding device somehow exceeds the tolerance time of normal mode, the normal mode will not activate the appliance. At this time, an emergency mode can be used to solve the problem. The emergency mode operates exactly like the normal mode, but the tolerance time of decoding device is larger. Nevertheless, the system security is reduced in this mode, and it is noted that one shall not leave during the period of tolerance time after an appliance is activated.

3) Synchronized mode: If both normal mode and emergency mode can't force decoding device to operate, then the system enters into synchronized mode. This mode is more lenient toward the decoding device end in the content checking, e.g. only compares the identity and the tolerance time, etc. This mode is the same as the above-mentioned emergency mode but has a lower system security, which pays more attention to the problem that resist “mask-replay” attacks within the tolerance time.

2.N: The identity (N) is 2 bytes in length and is used for testing and verifying the associated encoding device, and its content includes product number and other parameters.

3. T_{T}: The transmitting time (T_{T}) is 4 bytes in length and is used to check whether the time difference between the timer of the encoding device and the timer of the associated encoding device is within tolerance time.

Moreover, the control signals are represented as plaintext M, and the ciphertexts are encrypted using a 64 bits symmetric key.

To cooperate with the embodiment of encoding device for remote controller according to the present invention, an associated decoding device 40 with reference to FIG. 4B comprises: a RF demodulator 36′, which is used to demodulate signals outputted from the encoding device; a key 34′; a decryptor 35′, which receives the demodulated signals and decrypts the signals into plaintext M by applying the key 34′; a timer 31′, which is used to generate a receiving time T_{R}; a controller 33′, which receives the plaintext and the receiving time; a register 37.

Please note that the content of the key 34, 34′ of the encoding device 30 and the decoding device 40 is the same. During the decoding operation, controller 33′ takes Mo, N and T_{T} out of M and then proceeds with the following procedure:

1) Evaluating whether N is correct, if not, then output is stopped;

2) If N is correct, make an evaluation to determine whether the signal is in normal mode, emergency mode or synchronized mode.

3) Comparing T_{T} and T_{R} to see whether the tolerance time is exceeded, i.e. checking whether |T_{T}−T_{R}|≦T_{L}. If answer is yes, then the output is normally actuated, otherwise the system will stop operating. Only in synchronized mode that the receiving end merely checks the identity, or similar to the above method that checks the tolerance time except for the tolerance time T_{L} is set to be larger so that the output apparatus is much easier to activate. (The content checking of the three decoding device mode can be adjusted according to the system requirement).

4) No matter it is in normal mode, emergency mode or synchronized mode, after the decoding device confirms the input is correct, then the output device is activated and T_{T} is recorded to check whether the signal is a replay signal or not.

5) While redesigning, the transmitting time T_{T} and the receiving time T_{R} are synchronized, i.e. let T_{R}=T_{T}, so as to prevent a cumulative error from happening.

In case of normal mode, emergency mode and synchronized mode all can not actuate the decoding device, it means that the timing difference between the encoding device and decoding device is very large or the device is malfunctioning, so that the apparatus shall be send back for resetting or overhauling.

In the present invention, a timer can be accomplished by a single-chip timing-interrupt method, or by a setup of another timing apparatus. That is, if a logic circuit is the only option in considering cost factor, circuit complexity, and electricity consumption of the encoding device, then a simple timing circuit can be used as the timing apparatus. Since the foregoing factors have less effect on the decoding device, thus, usually a single-chip is installed and either a timing-interrupt method or another timing circuit is used as the timer. A timer does not need to synchronize with present time and also does not need to have a high resolution as accurate as an ordinary timing apparatus, e.g. watch etc., to the extent of millisecond, or even microsecond. It is merely a simple timing apparatus that a 0.5 second resolution is sufficient. Moreover, to achieve the effect of security, initial value of a timer can be a random number, i.e. the initial value is not zero, so that an attacker is difficult to hit the nail on the head.

To ensure security and normal operation of a system, timer should comply with the requirements that outputs are not repeated easily and timers of the encoding device and the decoding device are synchronized.

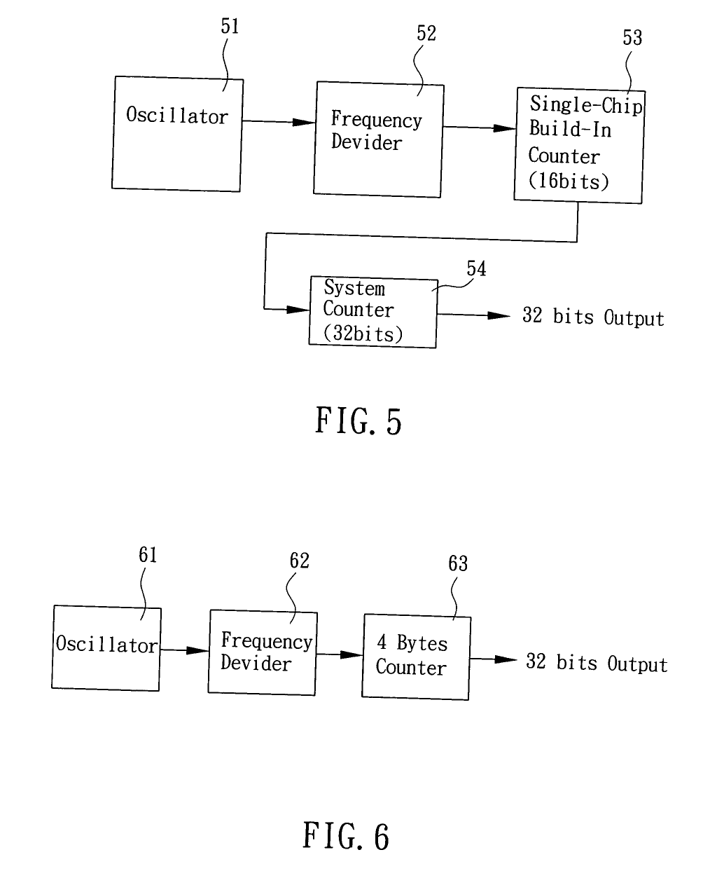

Considering a single-chip HT48C50 of Holtek Semiconductor Inc., if a 400 KHz oscillator is adopted and a 16 bites timer is set to interrupt every 0.5 second, then to generate 2³² times interrupt require about 24855 days. Namely, if the timings are outputted to four registers, then to finish a cycle requires about 68 years. Therefore, the repeating phenomenon of timing signals need not be considered. Referring to FIG. 5 and FIG. 6, which are two block schematic diagrams that respectively illustrate an embodiment of timer applying a single-chip timing-interrupt method and a timing logic circuit. In FIG. 5, a timer is realized by a single-chip timing-interrupt method, which comprises: an oscillator 51, a frequency divider 52, a single-chip built-in counter 53, and a system counter 54. In FIG. 6, a timer is realized by a logic circuit, which comprises: an oscillator 61, a frequency divider 62, and a counter 63.

Considering the synchronization of two timers of the encoding device and the decoding device, the stability of a modem-day timer is about ±10·10⁻⁶, that is, an one minute error is generated every 69 days; The maximum timing difference generated between the receiving end and the transmitting end is 20·10⁻⁶, namely about 2 sec/day. If the tolerance time is set to be one minute, there is no need to consider an unsynchronized condition between the receiving end and the transmitting end within 34 days. To avoid the embarrassment that the decoding device can't operate caused by timing errors between the receiving end and the transmitting end, the system should apply software to adjust the tolerance time T_{L} appropriately.

The tolerance time T_{L} can be programmed as following:

T_{L}=α·Tₛ+C

Tₛ=T_{d}·A_{C}

wherein α: as a constant that can be adjusted according to necessity, for instance, α can be 1˜2 when in normal mode, α can be 3˜5 when in emergency mode, α can be 5 and above when in synchronized mode.

T_{d}: as a time-between-operations.

Tₛ: as a safe time, which is the maximum timing error between timers of receiving end and transmitting end.

C: as a time constant, which is used to ensure normal operation of the system. Without the parameter C in the above function, when a key is pressed twice successively, T_{d} will be very small and cause T_{L}≈0. Therefore, when a key is pressed the second times, because of the time difference caused by timing-carry of the receiving end and the transmitting end, the decoding device might not be able to operate. The value of C is usually set to be 0.5 second.

A_{C}: as a value, which is the addition of accuracy of the receiving end and the transmitting end.

For instance, if both the accuracy of the receiving end and the transmitting end are ±10·10⁻⁶, then A_{C}=20·10⁻⁶, and the maximum timing difference between the receiving end and the transmitting end is about 2 sec/day. If current operation is ten days away from the previous successful operation, then Tₛ=T_{d}·A_{C}=10 days·20·10⁻⁶=17.28 sec. If α=1.5 and C=0.5 sec, then the tolerance time T_{L}=α·Tₛ+C=1.5*17.28 sec+0.5 sec=26.42 sec, that is, if a person who fails a transmission but does not leave until after 26.5 sec, consequently, attackers can not use mask-replay method to actuate the decoding device.

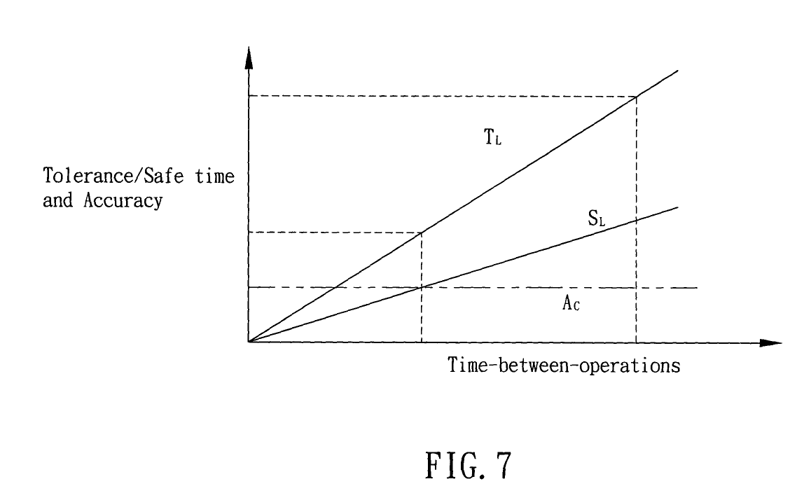

FIG. 7 is a chart that illustrates the relationship between tolerance time, safe time Tₛ, timing chip accuracy A_{C} and time-between-operation of the decoding device.

If signals are masked by attackers and can not be received by the receiving end, the receiving end will not react. If a common user can not activates an apparatus, it is accustomed to linger at the scene for a period of time before leaving. If after the tolerance time T_{L} had passed, attackers then replay the received signal to the receiving end, since the timing value of the receiving end is more than T_{L}, so that the decoding device won't operate normally and the attack fails. If attackers keep trying to replay the signals, it will take 24855 days for the timer to come back to its original value, so that it is hard for attackers to break into the system through replaying. The “mask-replay” attack can be divided into the following two conditions:

1) The system is not operating for a long time, i.e. T_{d}>>0, so that the tolerance time is enlarged and user is required to linger longer before leaving (referring to the above-mentioned, if current operation is ten days away from a previous successful operation, one should not leave until after 26.5 sec), so as to ensure the security of the system. Otherwise, if an attacker applies a mask-replay attack, since the tolerance time is larger, the attack might succeed.

2) Right after the system finishes a successful operation, the user immediately proceed with another operation, at the same time an attacker carries out a mask-replay attack, so that the legit user can not executes an operation normally. Since T_{d}≈0 of the system, even though the user leaves immediately, the attacker can not activates output and fails the attack.

The decoding device has a plural set of registers to store used T_{T}, hence, if an attacker eavesdrops a normal operating signal and replays the signal immediately, the system is able to detect the repeat signal sent by the attacker and rejects to act according. Moreover, if an attacker waits a period of time before replaying the signal, the system is also able to detect the attack and stop outputting since the tolerance time is over passed.

Because of the timing of the decoding device is reset to be the same as time of the encoding device after each execution, and furthermore is appropriately adjusted using the tolerance time controlled by software according to time interval between activation, therefore, there is no cumulative error and no need to worry the synchronization problem.

While the system adopts a secured encryptor, e.g. DES etc., an attacker requires 2⁵⁶ μs to guess the keys of both the transmitting end and the receiving end (assuming that computers used by attackers can execute a million guessing within a second), that is about 2285 years. Furthermore, since a relevant plaintext is not sent by the system, it is difficult for attackers to reckon the correct keys lacking the plaintext to compare with thereof ciphertext.

The hardware and software of the system is very simple, whose complexity is similar to those commercial products currently on the market without adding excessive circuits and operations. The comparison between the present invention and the remote control system illustrated in U.S. Pat. No. 5,517,187 is shown in table 1:

TABLE 1
The comparison between the present invention and the remote
control system illustrated in U.S. Pat. No. 5,517,187

System

| | | U.S. Pat. No. |
|---|---|---|
| Item | The present invention | 5,517,187 |
| Key know-how | 32 bites timer | 32 bites timer |
| Length of key | 64 bites | 64 bites |
| Ability to resist | Yes | Yes |
| “replay” attack | Required a plural set of 32 | But if under successive |
| | bits register to store the | replay, the attack may |
| | used T_{T} | succeed. |
| Ability to resist | Yes | No |
| “mask-replay” | After a long idle time, a | |
| attack | longer tolerance time is | |
| | required before leaving. | |

Hereinafter, a method to improve the electricity consumption problem of remote controller is illustrated according to the present invention to expand the life span of the battery.

The encoding device and the decoding device for remote control system according to the present invention are both equipped with timer, and are both installed with encryptor, e.g. DES etc., and crypto-key K. Once timer is activated, the timing is non-stop. For the decoding device of the receiving end, a stationary power supply is applicable usually because of the location where it is installed. Therefore, there is less consideration for electricity consumption at the receiving end. On the other hand, the encoding device of the transmitting end employs batteries for ordinary hand-held appliances as its power supply, consequently the power-saving or battery-changing issue must be taken into consideration at the transmitting end. Under the power-saving consideration, the means provided in the present invention are still applicable. The followings are two power-saving methods:

The first method: except for the foregoing encrypt-decrypt method, the comparison of timing value can be replaced by the comparison of the value of difference, namely, to activate timer for a period time only at each time the transmitting end is actuated. Thought the timing value of the transmitting end may be different from the timing value of the receiving end, since the same timing frequency is used as a design base for the two timers, both timers have the same timing speed. Hence, the decoding device of the receiving end can compare the timing speed of its timer to make sure that the encoding device of the transmitting end is an accompanying device of the receiving end. In another word, while the transmitting end starts to operate, the timer is actuated and is successively sending out changing timing values, the receiving end thereafter compares the timing frequency of the timer of the transmitting end with its own to decide whether it is a matching remote controller.

The second method: after the transmitting end idles for a period of time, its timer will cease timing, which won't start operating until a user presses a key of the remote controller of the transmitting end. Since the values of timer of the transmitting end and the receiving end are not the same under the circumstance. Therefore, a signal that is transmitted first must be used as a compelling synchronized mode signal. As soon as the receiving end receives the compelling synchronized mode signal, the timer of the receiving end can be synchronized with the timer of the transmitting end, thus the next signal transmitted can be evaluated according to normal method as mentioned previously. Since only the first signal transmitted after the stopping of timer of the transmitting end is the compelling synchronized mode signal whose length is merely about several microseconds, therefore, users will not feel a sensation of delaying. Because a normal signal will be transmitted right after the transmission of the compelling synchronized mode signal, or users will be required to press the transmission key twice successively after a remote controller is idled for a period of time, then the receiving end can be actuate. The first press is to send out the compelling synchronized mode signal and the second press is simply to send out a normal signal. For the sake of security, to prevent the compelling synchronized mode signal and the successive normal signal are eavesdropped and recorded, a further precautions is to enable the receiving end to record the first few times of the timing values during the compelling synchronized mode. If the records are the same, it represents that they are duplicated signals from an attacker, then no operation will be actuated.

The foregoing methods for improving the electricity consumption problem of remote controller can be represented as following: activating encoding device; activating timer of the encoding device; encrypting the transmitting timing and the identity of the timer while sending out thereof to the decoding device; the decoding device compares the received data with its own timing; if under compelling mode, then the timer of the decoding device is synchronized with the timer of the encoding device; if under normal mode, then the decoding device make a evaluation to decide whether the encoding device should be activated according to the timing value received; for the sake of power-saving, the controller of the encoding device evaluates whether a key is pressed or not during a period of time, the power-saving apparatus is actuated and the electricity is automatically disconnected if no key is pressed; No matter under which mode, the final timing value of the transmitting end is stored in its memory. General speaking, while the first time a decoding device receives a signal, the timing difference is too large so that the controlled apparatus is not be able to activate. But after synchronized by the timer, the second received signal should be able to activate the apparatus.

Owing to the limiting computational capability, a single-chip or other electronic apparatuses of general encoding device can not rapidly accomplish somewhat complex operations, e.g. the modular multiplication or modular exponentiation, that are required in the asymmetric system. Hence, a symmetric key crypto-system is more appropriated. For example, in the DES system which is still considered by the public to be a safe system that the time required to execute an one-time encryption or decryption by applying symmetric method on a single-chip is about several microseconds. Therefore, no time delaying problem is incurred in the application. Thought a newly promulgated encryption standard AES will replace the twenty-year-old DES, the present invention can adapts the encryptor used in the system to AES. Only the key of AES is longer, the time required to encrypt-decrypt is longer.

In summary, the present invention illustrates a high-security encoding device for remote controller whose characteristics is replacing the counter used in the prior arts by a timer, so that make a “mask-replay” attack hard to succeed. Hence, the security of remote control system is enhanced and also the electricity consumption problem of remoter controller is improved. Consequently, the present invention has been examined to be progressive and has great potential in commercial applications.

Those skilled in the art should appreciate that they can readily use the disclosed conception and specific embodiments as a basis for designing or modifying other structures for carrying out the same purpose of the present invention, and that various changes, substitutions and alterations can be made herein without departing from the spirit and scope of the invention as defined by the append claims.

What is claimed is:

1. A high-security encoding device for remote controller, comprising:
a timer used to provide a transmitting time;
a mode selector used to provide a mode select value;
a controller, by which an identity, said transmitting time, and said mode select value are received to generate a control signal;
a key;
an encryptor, which receives said control signal and applies said key to encrypt said control signal to a ciphertext; and
a RF modulator, which modulates and outputs said ciphertext.

2. The high-security encoding device for remote controller as recited in claim 1, wherein said timer is a 32 bits timer.

3. The high-security encoding device for remote controller as recited in claim 1, wherein said key is a 64 bits key.

4. The high-security encoding device for remote controller as recited in claim 3, wherein said key is stored in a non-volatile memory.

5. The high-security encoding device for remote controller as recited in claim 1, wherein said transmitting time is four bytes in length, which is used to check whether time difference between the timer of the encoding device and the timer of the associated encoding device is within a tolerance time.

6. The high-security encoding device for remote controller as recited in claim 1, wherein said mode select value is 2 bytes in length, by which a mode is chosen among the normal mode, emergency mode, and synchronized mode according to actual need.

7. The high-security encoding device for remote controller as recited in claim 1, wherein said identity is 2 bytes in length, which is used for testing and verifying the associated decoding device.

8. The high-security encoding device for remote controller as recited in claim 1, wherein said control signal is represented as plaintext

9. The high-security encoding device for remote controller as recited in claim 1, wherein said ciphertext is encrypted using a symmetric key with 64 bits in length.

10. The high-security encoding device for remote controller as recited in claim 1, wherein an initial value of said timer is a random number.

11. The high-security encoding device for remote controller as recited in claim 10, wherein said timer is realized by a logic circuit

12. The high-security encoding device for remote controller as recited in claim 10, wherein said timer is realized by the single-chip timing-interrupt method.

13. A high-security encoding device for remote controller, comprising:
a timer, which is used to provide a transmitting time, and said timer only timing a few seconds while said encoding device for remote controller is actuated in order to save electricity;
a mode selector, which is used to provide a mode select value;
a controller, by which an identity, said transmitting time, and said mode select value are received to generate a control signal;
a key;
an encryptor, which receives said control signal and applies said key to encrypt said control signal into a ciphertext; and
a RF modulator, which modulates and thereafter outputs said ciphertext.

14. The high-security encoding device for remote controller as recited in claim 13, wherein an operating method for the device comprising:
activating said encoding device;
activating said timer of said encoding device;
encrypting said transmitting timing and said identity of said timer, and said compelling synchronized mode value while sending out to an external decoding device to enable said decoding device to carry out a synchronized action;
evaluating whether or not said decoding device is activated once again during a period of time;
if not, then stop timing, but a final timing value is still stored in memory;
if yes, then an encrypted signal containing no said compelling synchronized mode value is sent.
